(19) United States
(12) Patent Application Publication
(10) Pub. No.: US 2023/0288339 A1
(43) Pub. Date: Sep. 14, 2023

(54) Rapid Optical Analysis System

(71) Applicant: Steven Marc Barnett, Elk Grove, CA (US)

(72) Inventor: Steven Marc Barnett, Elk Grove, CA (US)

(21) Appl. No.: 17/689,316

(22) Filed: Mar. 8, 2022

(51) Int. Cl. G01N 21/64; G01N 21/65; G01N 21/27

(52) U.S. Cl. CPC G01N 21/6456; G01N 21/65; G01N 21/27; G01N 2021/6471; G01N 2021/6497

(57) ABSTRACT

This invention describes a device with two or more point detectors, one of more other optics, and appropriate data handling hardware and software when combined with a coupled apparatus to rapidly detect/characterize data for the chemical and/or physical measurement of materials on a two-dimensional surface.

### CROSS-REFERENCE TO RELATED APPLICATIONS

This application claims priority to U.S. Provisional Patent Application 63/207,576 filed on Mar. 9, 2021.

### STATEMENT REGARDING FEDERALLY SPONSORED RESEARCH OR DEVELOPMENT

“Not Applicable”

### THE NAMES OF THE PARTIES TO A JOINT RESEARCH AGREEMENT

“Not Applicable”

### INCORPORATION-BY-REFERENCE OF MATERIAL SUBMITTED ON A COMPACT DISC OR AS A TEXT FILE VIA THE OFFICE ELECTRONIC FILING SYSTEMS (EFS-WEB)

“Not Applicable”

### STATEMENT REGARDING PRIOR DISCLOSURES BY THE INVENTOR OR A JOINT INVENTOR

“Not Applicable”

### BACKGROUND OF THE INVENTION

This invention describes a device for the rapid acquisition of data that may be used for the optical analysis of a two-dimensional surface when combined with two-dimensional spatial data transmitted to the device from a coupled apparatus. The ability to generate one or more images from this two-dimensional data is also including in this invention. This device utilizes point detectors to permit rapid data acquisition that may not be possible with other schemes to acquire similar data.

### PRIOR ART

The measurement of optical features on a two-dimensional surface is a well-known technique for the characterization of many materials. Traditionally, this was done by rastering the position of the sample under an optical source that would generate the light used for analysis (Vandenabeele et al.). Each position would generate a full spectrum through the use of a CCD or some other type of multiplexed spectral detection system.

Subsequent work used systems that incorporated an expanded source on the surface, a two-dimensional detector, and other optical components that could be used to provide spectral information at each pixel. For example:

FT-IR spectral imaging incorporating an FTIR as part of the optical system so that a full FTIR spectrum is obtained at each pixel (Lewis et al.),

Raman spectral imaging incorporates an expanded laser beam with two-dimensional detectors and a spectral-resolving component such as a Liquid Crystal Tunable Filter (LCTF) (Stewart et al.).

Other methods have used a source beam to raster on the surface of a sample while spectra are acquired using a device such as a CCD that acquires the full spectrum in a given spectral range (Emetere et al.).

All of these methods provide valuable information on the two-dimensional distribution of chemical and/or physical components on a surface. However, by necessity, the hardware required to perform these measurements simultaneously acquires quite a bit of superfluous information that is not required for the analysis. As a result, these measurements often take more time than are needed for certain analyses.

There are cathodoluminescence methods that use three filters and three detectors to acquire red, green, and blue cathodoluminescence light—this technique is often used for geological samples (e.g., Pagel et al., 2000). While this technique does allow for rapid imaging, it is a general technique and does not incorporate filtering of light based on specific chemical or physical structures in a material being analyzed.

### BRIEF SUMMARY OF THE INVENTION

The device proposed here incorporates multiple optics and detectors which are used to detect specific chemical or physical structures in a material. This device, when operated with a coupled apparatus to provide two-dimensional data on the location on a surface where the light is being generated, provides for a novel means of data analysis, allowing for the counting of structures on a two-dimensional surface, or for imaging.

### BRIEF DESCRIPTION OF THE SEVERAL VIEWS OF THE DRAWINGS

This invention consists of a device with a number of discrete components that are used to generate data from a two-dimensional material of interest. These include:

1. An Optical Engine that includes two or more point detectors,

2. One or more elements within the Optical Engine that allows light to be separated spatially as a function of wavelength such that light of a specific wavelength range is incident on a particular detector and each detector is used to detect light of a separate wavelength range,

3. A data interpretation system that combines data from the point detectors with two-dimensional positional information from a coupled apparatus to count specific chemical and/or physical areas of interest across a two-dimensional surface, through counting these regions and/or by generating an image.

### PREFERRED EMBODIMENT OF THE OPTICAL ENGINE

### Optical Engine 1: Collection Device Based on Lightpipe and Optical Elements for Wavelength Separation onto Separate Point Detectors

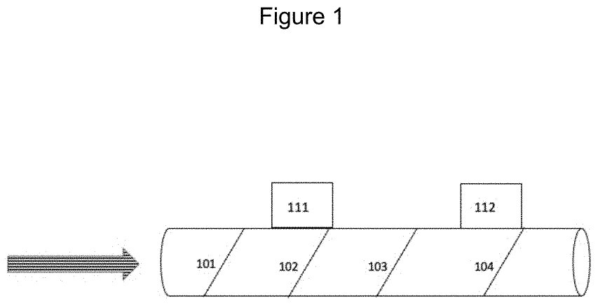

This device would incorporate a lightpipe and specific optical elements to select wavelengths of light for measurement at two or more detectors. FIG. 1 shows a typical example of how a lightpipe would be implemented in this configuration. The components of this system (as labelled in FIG. 1) would include:

F1-F4: Bandpass filters to transmit certain wavelengths of light and reflect other wavelengths of light. Note: this Figure represents four bandpass filters but there may be more or less optical elements in this embodiment.

Det1, Det2: Point detectors to detect light that falls onto the detector. This invention includes two or more detectors. For simplicity, two detectors are shown in FIG. 1.

In combination with the filters shown, Det1 would detect light that falls between I_{F1} and I_{F2} and Det2 would detect light that falls between I_{F3} and I_{F4}.

The first filter (F1) may be positioned before the lightpipe. The final optical element in this device may be a mirror or may be omitted and the detector placed in the path of the incoming light.

The detectors may be any device that converts electromagnetic radiation (light) impingent on a detector element and converting that into an electrical or digital signal.

### Alternative Embodiment of the Optical Engine: Collection Device with Same Orientation as the Preferred Embodiment

This alternative embodiment could occur without placing the optics in a lightpipe. The optics could be placed inside another structure or could be present in free space.

### Alternative Embodiment of the Optical Engine: Collection Device with Alternative Orientation of Filters and Detectors

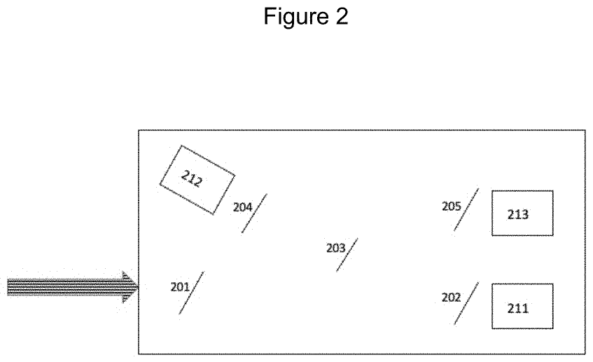

In this embodiment, a lightpipe is not used and the optical filters and detectors have a different relative configuration. This embodiment is depicted in FIG. 2 where Filters F5-F9 represent bandpass filters for use with Detectors DET3-DET5.

### Coupling of Light Into Optical Engine

It is envisioned that light may be coupled into the optical engine shown in FIG. 1 through a range of techniques. As two examples, light may be coupled directly or through a fiber-optic interface.

### Description of Certain Components That are Included in This Invention

Some examples of specific components that are envisioned as part of this invention include:

The source (item 1) may be a laser, a synchrotron, an electron beam, or another stimulus or form of energy that causes an optical signal to emanate from the sample. As part of this measurement, the source is moved along a one- or two-dimensional surface and the coordinates at any moment are transmitted to the device described here. The source could also be the sample itself for cases where the sample is emanating light naturally or as a result of other stimulus (e.g., electrical).

The hardware and firmware/software to move the source on the sample (item 2) may be one or more mirrors, prisms, lenses, liquid crystals, scanning coils, deflector plates, or other elements that may be used to move the position of the source on the sample.

The Optical Engine (item 4) may include a lightpipe or some other device that contains two or more detectors in specific positions so that the light detected at that detector corresponds to a specific range of wavelengths.

The Optical Engine may also be comprised of two or more Optical Sub-engines where each Sub-engine comprises light of a certain wavelength range.

### Systems Envisioned With This Optical Imaging System

All systems described here will be considered to incorporate direct optical coupling. As mentioned above, these may also be fiber-optically coupled or have some other form of optical coupling.

### Microscope Interface

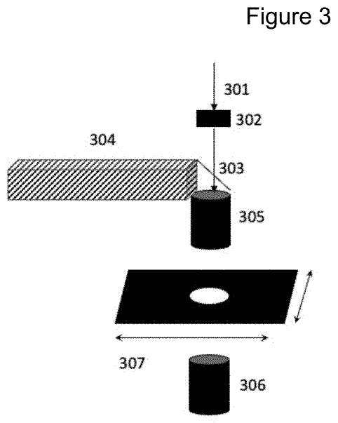

One implementation of this optical engine can be with a microscope where the source used to generate the optical signal is rastered on the surface of a sample. FIG. 3 shows how this is implemented with the following components:
S—Source used to generate the optical signal from the sample,
RO—Rastering optics that control the location of the source on the sample,
WSO—Wavelength selective optics—used to allow the Source light to transmit and light from the sample is directed into the optical engine,
FO—(optional) Focusing optics that serve to focus the light onto the sample. Note that there is an FO below the sample for situations where a transmission measurement through the sample is performed,
ST—Stage with motorized XY control. The rastering motion of S can be used to generate an image. This can be combined with a motorized XY stage to build up larger images,
OE—Optical engine as shown in FIG. 1 for light collection and detection to generate data used in combination with location of the source on the sample to generate one or more images.

Note: RO may be located after (below) the WSO.

### DETAILED DESCRIPTION OF THE INVENTION

### Embodiment for Measurement of Raman G and 2D Bands of Graphene

The collection device illustrated in either the preferred or alternate embodiment may be used for the detection of Raman scattered light. In one example, this device may be used for measurements on graphene to determine the presence of single layers of graphene. Using 532 nm excitation, the G band of graphene would be observed near 1580 cm⁻¹ and the 2D band would be observed near 2700 cm⁻¹. For measurement of the G and 2D band with this device, FIG. 1 would have longpass filters at the following wavelengths with light falling on Detectors 1 and 2 in the preferred embodiment as shown below:

| | Wavelength | Raman shift | |
|---|---|---|---|
| Filter | (nm) | (cm⁻¹) | Comment |
| F1 | 579.81 | 1550 | Light from 1550-1610 cm⁻¹ |
| F2 | 581.84 | 1610 | is incident on Det1 (G band) |
| F3 | 619.31 | 2650 | Light from 2650-2850 cm⁻¹ |
| F4 | 627.08 | 2850 | is incident on Det2 |
| | | | (2D band) |

An equivalent set of filters and detectors may be used in the Alternate Embodiment for measurement of the G and 2D bands of graphene.

Other lasers may be used for this measurement—this would result in different filters being used but either the Preferred or the Alternate Embodiment can be used with a different laser.

### Embodiment for the Measurement of Chemical Composition of Microplastics on a Surface

The same design illustrate for graphene could be used for a system to measure the chemical composition of microplastic particles. As one example, a Raman system can easily be configured to measure polystyrene (PS) and polyethylene (PE). Polystyrene exhibits a very strong Raman band near 1001 cm⁻¹ and polyethylene exhibits a strong Raman band near 1294 cm⁻¹. Using 532 nm excitation, filters in the preferred embodiment could be used as shown below:

| | Wavelength | Raman shift | |
|---|---|---|---|
| Filter | (nm) | (cm⁻¹) | Comment |
| F1 | 560.35 | 951 | |
| F2 | 563.51 | 1051 | Light from 951-1051 cm⁻¹ is |
| | | | incident on Det1 (PS band) |
| F3 | 569.70 | 1244 | Light from 1244-1344 cm⁻¹ |
| F4 | 572.97 | 1344 | is incident on Det2 |
| | | | (PE band) |

Additional optical elements and detectors can be added to this configuration to detect other plastics.

This same design could be used for the Raman detection and characterization of microplastics using 785 nm excitation.

| | Wavelength | Raman shift | |
|---|---|---|---|
| Filter | (nm) | (cm⁻¹) | Comment |
| F1 | 848.33 | 951 | Light from 951-1051 cm⁻¹ is |
| F2 | 855.59 | 1051 | incident on Det1 (PS band) |
| F3 | 869.95 | 1244 | Light from 1244-1344 cm⁻¹ |
| F4 | 877.59 | 1344 | is incident on Det2 |
| | | | (PE band) |

This same design could be used for the Raman detection and characterization of microplastics using 1064 nm excitation.

| | Wavelength | Raman shift | |
|---|---|---|---|
| Filter | (nm) | (cm⁻¹) | Comment |
| F1 | 1183.78 | 951 | Light from 951-1051 cm⁻¹1 is |
| F2 | 1197.96 | 1051 | incident on Det1 (PS band) |
| F3 | 1226.32 | 1244 | Light from 1244-1344 cm⁻¹ |
| F4 | 1241.54 | 1344 | is incident on Det2 |
| | | | (PE band) |

### Embodiment for Photoluminescence Spectroscopy of Aluminum Gallium Nitride species

The design in FIG. 1 may be used for photoluminescence spectroscopy detection. For example, using 197 nm excitation, the relative elemental composition of AlₓGa₁₋ₓN may be monitored by observing the photoluminescence bands emitted at 298 and 358 nm.

| | Wavelength | |
|---|---|---|
| Filter | (nm) | Comment |
| F1 | 288 | Light from 288-308 nm is |
| F2 | 308 | incident on Det1 |
| F3 | 348 | Light from 348-368 nm is |
| F4 | 368 | incident on Det2 |

### Embodiment for Cathodoluminescence Spectroscopy of Gallium Nitride

The design in FIG. 1 may be used for cathodoluminescence spectroscopy detection. For example, in one type of structure with an InGaN underlayer and GaN quantum wells, the InGaN underlayer emits at 395 nm while the GaN quantum wells emit at 450 nm. These two structures may be monitored with the device shown in FIG. 1 using the configuration shown below:

| | Wavelength | |
|---|---|---|
| Filter | (nm) | Comment |
| F1 | 375 | Light from 375-415 nm is |
| F2 | 415 | incident on Det1 |
| F3 | 425 | Light from 425-475 nm is |
| F4 | 475 | incident on Det2 |

### Embodiment for the Monitoring of Lipids and Proteins Using Infrared Absorption or Reflectance Spectroscopy

The design in FIG. 1 may be used for infrared absorption or reflectance measurements. For example, in samples containing biological material, proteins absorb infrared light at 1650 cm⁻¹ and lipids absorb infrared light in the 2800-3000 cm⁻¹ region.

These two species may be monitored with the device shown in FIG. 1 using the configuration shown below:

| | Frequency | Wavelength | |
|---|---|---|---|
| Filter | (cm⁻¹) | (mm) | Comment |
| F1 | 3000 | 3.33 | Light from 2800-3000 cm⁻¹ is |
| F2 | 2800 | 3.57 | incident on Det1 (lipids) |
| F3 | 1700 | 5.88 | Light from 1600-1700 cm⁻¹ is |
| F4 | 1600 | 6.25 | incident on Det2 (proteins) |

### Other Applications

This type of detection method can also be used for fluorescence detection in a manner similar to the Raman or photoluminescence detection configurations.

### Bulk Reflectance/Scattering/Transmission

Similar to the microscope configuration, the optical engine may be combined with a rastering mechanism for reflectance, scattering, transmission, or other measurements without the use of a microscope.

For reflectance, this may also be configured for measuring the reflectance or scattering off a surface such as a wall, a vehicle surface, or some other sample that is too large to be placed inside a typical scientific instrument.

### Electron Microscope Interface

This measurement configuration may be implemented with an electron microscope where the electron beam is used to generate an optical signal from the sample. The electron beam is rastered along the surface and the Optical Engine represented in FIG. 1 is used to detect the light coming from the sample.

### X-Ray Source

This system may use an X-ray source incident on the sample. Rastering of the X-ray source on the surface combined with the Optical Engine depicted in FIG. 1 would allow for the generation of images of the optical signal generated by the X-ray source.

The invention claimed is:

1. A device to generate data across a two-dimensional area, the device comprising:
two or more optical point detectors, one or more optical elements to cause light of different wavelength ranges to fall on each detector, and a system to calculate information by combining data from more than one of the detectors with data from a coupled apparatus that provides information on the two-dimensional position where light is coming from on the surface of a material being analyzed at any specific time.

2. The device in claim 1 comprising optical elements that are optical filters,

3. The device in claim 1 comprising one or more detectors that convert light incident onto the detector into an electrical signal,

4. The device in claim 1 comprising one or more detectors that convert light incident onto the detector into a digital signal,

5. The device in claim 1 comprising one or more filters that are short bandpass filters,

6. The device in claim 1 comprising one or more filters that are long bandpass filters,

7. The device in claim 1 comprising one or more filters that block light both shorter and longer than a desired wavelength range,

8. The device in claim 1 where an image is generated by combining the positional information from more than one location on the material being analyzed with information from one of more of the detectors at each position,

9. The device in claim 1 where the coupled apparatus includes a component that causes light to be emitted from a specific two-dimensional position on the material being analyzed at any specific time,

10. The device in claim 1 where the two-dimensional position of light coming from the material being analyzed is rastered along the surface of the material being analyzed,

11. The device in claim 1 where the coupled apparatus generates Raman-scattered light for analysis by the device,

12. The device in claim 1 where the coupled apparatus is an electron microscope that uses an electron beam incident on a material being analyzed to generate light and the device is configured to detect specific chemical and/or physical properties of the material being analyzed light upon exposure to the electron beam,

13. The device in claim 1 where the coupled apparatus generates light from the material being analyzed due to photoluminescence or chemiluminescence,

14. The device in claim 1 where the coupled apparatus is a synchrotron,

15. The device for imaging in claim 1 where the coupled apparatus generates fluorescence light from a material being analyzed,

16. The device for imaging in claim 1 where the coupled apparatus generates scattered light from a material being analyzed,

17. The device of claim 1 where more than one of the optical elements are incorporated in a lightpipe,

18. The device of claim 1 where light from the coupled apparatus is optically separated into two or more separate sub-devices.

19. The device of claim 1 where the coupled apparatus includes a microscope for collection of light from a sample.

20. The device of claim 11 where the coupled apparatus generates Raman scattered light for the analysis of microplastic materials,

21. The device of claim 11 where the coupled apparatus generates Raman-scattered light for the analysis of graphene,

22. The device of claim 12 where the coupled apparatus is an electron microscope for measurements on materials containing, at a minimum, gallium and nitrogen,

23. The device of claim 12 where the coupled apparatus is an electron microscope for measurements on materials containing, at a minimum, aluminum and nitrogen,

24. The device of claim 12 where the coupled apparatus is an electron microscope for measurements on materials containing gallium and arsenic,

25. The device of claim 13 where the coupled apparatus performs measurements on materials containing, at a minimum, gallium and nitrogen,

26. The device of claim 13 where the coupled apparatus performs measurements on materials containing, at a minimum, aluminum and nitrogen,

27. The device of claim 13 where the coupled apparatus performs measurements on materials containing gallium and arsenic,

28. A method for counting the number of discrete regions detected by the device in claim 1 by one of more of the detectors so that the total number of regions present in a given two-dimensional area can be counted.
